(19) United States
(12) Patent Application Publication
(10) Pub. No.: US 2024/0232658 A1
(43) Pub. Date: Jul. 11, 2024

(54) Method for detecting crisis for each industry and device therefor

(71) Applicant: KOREA INSTITUTE OF SCIENCE & TECHNOLOGY INFORMATION, Daejeon (KR)

(72) Inventors: Han Gook Kim, Seoul (KR); Jong Yi Hong, Gumi-si (KR); Yun Jeong Choi, Seoul (KR)

(21) Appl. No.: 18/401,986

(22) Filed: Jan. 2, 2024

(30) Foreign Application Priority Data
Jan. 6, 2023 (KR) 10-2023-0002121

(51) Int. Cl. G06N 5/022

(52) U.S. Cl. CPC G06N 5/022

(57) ABSTRACT

The present disclosure discloses a method of detecting crises for each industry and a device therefor. A crisis detection device includes a definition setting unit that redefines the meanings of crisis and crisis detection for each industry; a document analysis unit that analyzes literature on the crisis and the crisis detection that have been redefined; a model creation unit that creates a crisis detection model based on the momentum theory reflecting the trend of a crisis index and the crisis index up-side risk (CIUR) reflecting volatility, considering the analysis results; and a crisis prediction unit that predicts crises for each industry using the crisis detection model.

### CROSS-REFERENCE TO RELATED APPLICATION

This application claims priority to and the benefit of Korean Patent Application No. 10-2023-0002121 filed in the Korean Intellectual Property Office on Jan. 6, 2023, the entire contents of which are incorporated herein by reference.

### TECHNICAL FIELD

The present disclosure relates to a method of detecting crises, and, more particularly, to a method and a device for detecting crises for each industry that accurately predict a possible crisis in each industry.

### BACKGROUND

Recently, the global economic situation has been highly unstable and its volatility has become very high. A sudden crisis over a short period of time, rather than a continuous decline over a long period of time, can be deemed a serious risk to the entire industry.

Therefore, Korea's government, local governments, and individual companies have currently calculated and operated crisis-related indices.

However, only limited information on crisis prediction can be obtained through the leading economic index and the coincident economic index, which are main economic indices, and indices by individual companies cannot provide integrated information about the overall industry.

Accordingly, there is a need for research on how to predict the current industrial crisis more accurately.

### SUMMARY

In view of the above, the present disclosure is aimed at providing a method and a device for detecting crises for each industry through which crises for each industry are more accurately predicted based on the momentum theory, which reflects the trend of the past crisis indices, and the crisis index up-side risk (CIUR), which reflects volatility.

A crisis detection device according to the present disclosure may include a definition setting unit that redefines the meanings of crisis and crisis detection for each industry; a document analysis unit that analyzes literature on the crisis and the crisis detection that have been redefined; a model creation unit that creates a crisis detection model based on the momentum theory reflecting the trend of a crisis index and the crisis index up-side risk reflecting volatility, considering the analysis results; and a crisis prediction unit that predicts crises for each industry using the crisis detection model.

The definition setting unit may redefine the crisis as a phenomenon in which a crisis index rises due to internal and external changes in each industry and the crisis detection as a phenomenon in which the crisis index rapidly rises above a preset reference value.

The document analysis unit may analyze literature related to at least one of the status of research on the development of crisis detection models at the national project level, the status of research on variables affecting crisis detection at the corporate level, the status of research on the development of crisis detection models at the corporate level, prior overseas research on crisis prediction models, the momentum theory, and the crisis index up-side risk.

The model creation unit may calculate a normalized momentum value with a probability of an increase in a crisis index based on the momentum theory, use the crisis index up-side risk to calculate the value of the crisis index up-side risk focusing on the volatility of the past six periods, and create the crisis detection model based on the normalized momentum value and the value of the crisis index up-side risk.

The model creation unit may generate the crisis detection model by averaging the normalized momentum value and the value of the crisis index up-side risk.

The crisis prediction unit may apply the crisis index to the crisis detection model in order to predict crises in the period after period t, period t+1, and period t+2.

The crisis prediction unit may use the crisis detection model to analyze the background of the time point when the trend of the past crisis index changed suddenly and further use the results of the analysis to predict the crisis.

A method of detecting crises performed by a crisis detection device according to the present disclosure may involve redefining the meanings of crisis and crisis detection for each industry; analyzing literature on the crisis and the crisis detection that have been redefined; creating a crisis detection model based on the momentum theory reflecting the trend of a crisis index and the crisis index up-side risk reflecting volatility, considering the analysis results; and predicting crises for each industry using the crisis detection model.

The redefining of the meanings may involve redefining the crisis as a phenomenon in which a crisis index rises due to internal and external changes in each industry; and redefining the crisis detection as a phenomenon in which the crisis index rapidly rises above a preset reference value.

The analyzing of the literature may be for analyzing literature related to at least one of the status of research on the development of crisis detection models at the national project level, the status of research on variables affecting crisis detection at the corporate level, the status of research on the development of crisis detection models at the corporate level, prior overseas research on crisis prediction models, the momentum theory, and the crisis index up-side risk.

The creating of a crisis detection model may involve calculating a normalized momentum value with a probability of an increase in a crisis index based on the momentum theory; using the crisis index up-side risk to calculate the value of the crisis index up-side risk focusing on the volatility of the past six periods, and creating the crisis detection model based on the normalized momentum value and the value of the crisis index up-side risk.

In the predicting of crises for each industry, the crisis index may be applied to the crisis detection model in order to predict crises in the period after period t, period t+1, and period t+2.

In the predicting of crises for each industry, the crisis detection model may be used to analyze the background of the time point when the trend of the past crisis index changed suddenly, and the results of the analysis may be further used to predict the crisis.

A system for detecting crises according to the present disclosure may include a document providing device that provides literature related to crisis indices for each industry and domestic/foreign crisis detection and literature related to the momentum theory that reflects the trend of crisis indices and the crisis index up-side risk that reflects volatility; a crisis detection device that analyzes the provided literature, creates a crisis detection model based on the analysis results, and detects crises for each industry using the crisis detection model that has been created; and a user terminal that receives information on the detected crises for each industry and outputs the received information in order to allow a user to prepare for the crises, and the crisis detection device may include a definition setting unit that redefines the meanings of crisis and crisis detection for each industry; a document analysis unit that analyzes literature on the crisis and the crisis detection that have been redefined; a model creation unit that creates the crisis detection model based on the momentum theory and the crisis index up-side risk, considering the analysis results; and a crisis prediction unit that predicts crises for each industry using the crisis detection model.

According to the embodiments of the present disclosure, it may be possible to improve the accuracy of predicting crises for each industry by predicting them based on the momentum theory, which reflects the trend of the past crisis indices, and the crisis index up-side risk, which reflects volatility.

In addition, according to the embodiments of the present disclosure, it may be possible to quickly respond to crisis in each industry in a specific and detailed manner based on the prediction of the crises.

As a result, it may be possible to build systems for predicting crises for each industry.

### BRIEF DESCRIPTION OF THE DRAWINGS

The accompanying drawings, which are included to provide a further understanding of the present disclosure and are incorporated on and constitute a part of this specification illustrate embodiments of the present disclosure and together with the description serve to explain the principles of the present disclosure.

FIG. 1 is a view for illustrating the features of a system for detecting crises according to an embodiment of the present disclosure.

FIG. 2 is a block diagram for illustrating a device for detecting crises according to an embodiment of the present disclosure.

FIG. 3 is a block diagram for illustrating a control unit according to an embodiment of the present disclosure.

FIG. 4 is a diagram for comparing the momentum and the crisis index of the automobile and trailer manufacturing industry according to an embodiment of the present disclosure.

FIG. 5 is a diagram for comparing the crisis index up-side risk and the crisis index of the automobile and trailer manufacturing industry according to an embodiment of the present disclosure.

FIG. 6 is a diagram for comparing the crisis detection model and the crisis index of the automobile and trailer manufacturing industry according to an embodiment of the present disclosure.

FIG. 7 is a flowchart for illustrating a method of detecting a crisis according to an embodiment of the present disclosure.

FIG. 8 is a diagram for illustrating the results of predicting a crisis in the food manufacturing industry through the crisis detection device according to an embodiment of the present disclosure.

FIG. 9 is a diagram for illustrating the results of predicting a crisis in the beverage manufacturing industry through the crisis detection device according to an embodiment of the present disclosure.

FIG. 10 is a diagram for illustrating the results of predicting a crisis in the tobacco manufacturing industry through the crisis detection device according to an embodiment of the present disclosure.

FIG. 11 is a diagram for illustrating the results of predicting a crisis in the textile product manufacturing industry (excluding clothing) through the crisis detection device according to an embodiment of the present disclosure.

FIG. 12 is a diagram for illustrating the results of predicting a crisis in the manufacturing of clothing, clothing accessories, and fur products through the crisis detection device according to an embodiment of the present disclosure.

FIG. 13 is a diagram for illustrating the results of predicting a crisis in the leather, bag, and shoe manufacturing industry through the crisis detection device according to an embodiment of the present disclosure.

FIG. 14 is a diagram for illustrating the results of predicting a crisis in the manufacturing of wood and wood products (excluding furniture) through the crisis detection device according to an embodiment of the present disclosure.

FIG. 15 is a diagram for illustrating the results of predicting a crisis in the pulp paper and paper products manufacturing industry through the crisis detection device according to an embodiment of the present disclosure.

FIG. 16 is a diagram for illustrating the results of predicting a crisis in the printing and recording media reproduction business through the crisis detection device according to an embodiment of the present disclosure.

FIG. 17 is a diagram for illustrating the results of predicting a crisis in the manufacturing of coke briquette and refined petroleum product through the crisis detection device according to an embodiment of the present disclosure.

FIG. 18 is a diagram for illustrating the results of predicting a crisis in the chemicals and chemical products manufacturing industry (excluding pharmaceuticals) through the crisis detection device according to an embodiment of the present disclosure.

FIG. 19 is a diagram for illustrating the results of predicting a crisis in the manufacturing of medical substances and pharmaceuticals through the crisis detection device according to an embodiment of the present disclosure.

FIG. 20 is a diagram for illustrating the results of predicting a crisis in the rubber and plastic product manufacturing industry through the crisis detection device according to an embodiment of the present disclosure.

FIG. 21 is a diagram for illustrating the results of predicting a crisis in the non-metallic mineral products manufacturing industry through the crisis detection device according to an embodiment of the present disclosure.

FIG. 22 is a diagram for illustrating the results of predicting a crisis in the primary metal manufacturing industry through the crisis detection device according to an embodiment of the present disclosure.

FIG. 23 is a diagram for illustrating the results of predicting a crisis in the metal processing manufacturing industry through the crisis detection device according to an embodiment of the present disclosure.

FIG. 24 is a diagram for illustrating the results of predicting a crisis in the manufacturing of electronic components, computers, and video, audio, and communication equipment through the crisis detection device according to an embodiment of the present disclosure.

FIG. 25 is a diagram for illustrating the results of predicting a crisis in the manufacturing of medical, precision, and optical equipment and watches through the crisis detection device according to an embodiment of the present disclosure.

FIG. 26 is a diagram for illustrating the results of predicting a crisis in the electrical equipment manufacturing industry through the crisis detection device according to an embodiment of the present disclosure.

FIG. 27 is a diagram for illustrating the results of predicting a crisis in the other machinery and equipment manufacturing industry through the crisis detection device according to an embodiment of the present disclosure.

FIG. 28 is a diagram for illustrating the results of predicting a crisis in the automobile and trailer manufacturing industry through the crisis detection device according to an embodiment of the present disclosure.

FIG. 29 is a diagram for illustrating the results of predicting a crisis in the other transportation equipment manufacturing industry through the crisis detection device according to an embodiment of the present disclosure.

FIG. 30 is a diagram for illustrating the results of predicting a crisis in the furniture manufacturing industry through the crisis detection device according to an embodiment of the present disclosure.

FIG. 31 is a diagram for illustrating the results of predicting a crisis in the other product manufacturing industry through the crisis detection device according to an embodiment of the present disclosure.

FIG. 32 is a block diagram for illustrating a computing device according to an embodiment of the present disclosure.

### DETAILED DESCRIPTION

Hereinafter, with reference to the attached drawings, the embodiments of the present disclosure will be described in detail so that a person having ordinary skill in the technical field to which the present disclosure belongs can easily carry out them. However, the present disclosure can be performed in many different forms and is not limited to the embodiments described herein. In order to clearly describe the present disclosure, parts unrelated to the description have been omitted from the drawings, and similar reference numerals have been given to similar parts throughout the present disclosure.

In this specification and the drawings (hereinafter, referred to as “the present disclosure”), a description of a certain component is not repeatedly provided.

In addition, in the present disclosure, when a component is referred to as being “connected” to another component, the component may be directly connected to the other component, or there may be other components therebetween. On the other hand, in the present disclosure, when a component is referred to as being “directly connected” to another component, there are no other components therebetween.

Furthermore, the terms used in the present disclosure are only used to describe specific embodiments and are not intended to limit the present disclosure.

In the present disclosure, expressions in the singular form may include the meaning of the plural form unless they clearly mean otherwise in the context.

In addition, in the present disclosure, expressions such as “include” or “have” are only intended to indicate the presence of features, numbers, steps, operations, components, parts, or a combination thereof described therein, and do not preclude the presence or the addition of one or more other features, numbers, steps, operations, components, parts, or combinations thereof.

In the present disclosure, the expression “and/or” is intended to indicate that a combination of multiple items or any of them is included. In the present disclosure, the expression “A or B” may mean “A,” “B,” or “both A and B.”

Furthermore, in the present disclosure, detailed descriptions of well-known functions and features that may obscure the gist of the present disclosure will not be provided.

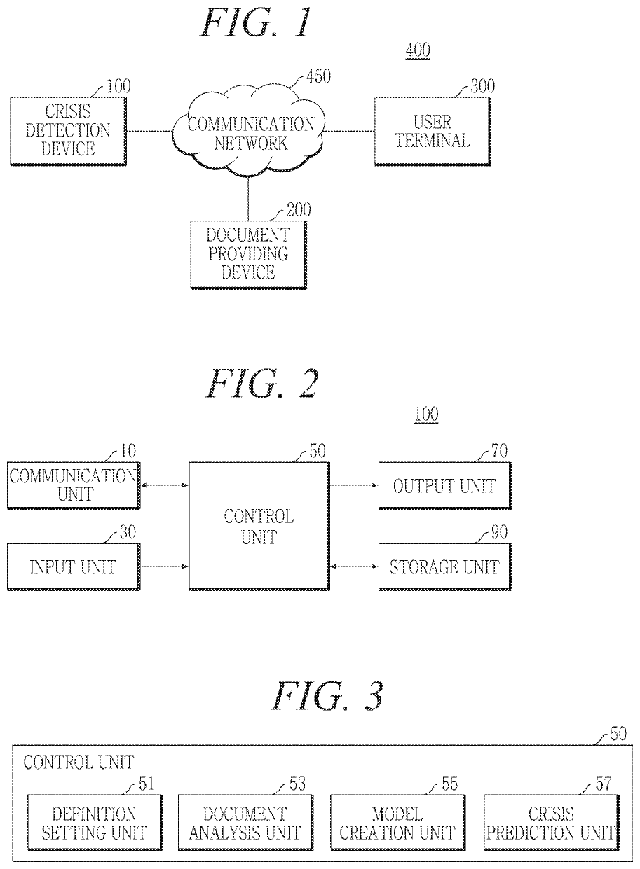

FIG. 1 is a view for illustrating the features of a system for detecting crises according to an embodiment of the present disclosure.

Referring to FIG. 1, a system for detecting crises 400 may predict crises for each industry, based on the momentum theory, which reflects the trend of the past crisis indices, and the crisis index up-side risk (CIUR), which reflects volatility, thereby improving the accuracy of predictions. As a result, the system for detecting crises 400 may facilitate preparations for the predicted crises. The system for detecting crises 400 may include a crisis detection device 100, a document providing device 200, and a user terminal 300.

The crisis detection device 100 may redefine the meanings of crisis and crisis detection for each industry. In other words, the crisis detection device 100 may distinguish between the concepts of industrial decline and crisis and redefine the meanings of crisis and crisis detection for each industry. The crisis detection device 100 may receive a document related to crisis detection with redefined meanings. The crisis detection device 100 may receive a plurality of documents from the document providing device 200 or directly from a user. The crisis detection device 100 may analyze received or input documents and design the basis of a crisis detection model. Here, the crisis detection device 100 may further analyze the theory of economic index trends and the concept of crisis detection models in financial literature. The crisis detection device 100 may create a crisis detection model based on the analysis results. The crisis detection model may be a model that predicts crises for each industry by analyzing the correlation with a crisis index. The crisis detection device 100 may predict crises for each industry based on the created crisis detection model.

The document providing device 200 may provide literature related to crisis indices for each industry and domestic/foreign crisis detection and literature on the momentum theory that reflects the trend of crisis indices and the crisis index up-side risk that reflects volatility. When the document providing device 200 receives a message to request literature from the crisis detection device 100, it may provide the literature requested by the message. That is, the document providing device 200 may be a server that serves as a storage for storing documents and providing the stored documents. In addition, although the document providing device 200 is shown as a single device in the drawings, a plurality of the document providing devices 200 may be provided in some system environments.

The user terminal 300 may be a terminal for a user (manager), and may receive information on predicted crises for each industry from the crisis detection device 100 and output the received information. As a result, the user terminal 300 may enable a user to intuitively recognize crises for each industry. In other words, the user terminal 300 may allow the user to prepare for the crises.

Meanwhile, the system for detecting crises 400 may build a communication network 450 between the crisis detection device 100, the document providing device 200, and the user terminal 300 for communication therebetween. The communication network 450 may include a backbone network and a subscriber network. The backbone network may include one or more of an X.25 network, a frame relay network, an ATM network, a multi-protocol label switching (MPLS) network, and a generalized multi-protocol label switching (GMPLS) network. The subscriber network may be a fiber to the home (FTTH), an asymmetric digital subscriber line (ADSL), a cable network, Zigbee, Bluetooth, Wireless LAN (IEEE 802.11b, IEEE 802.11a, IEEE 802.11g, and IEEE 802.11n), Wireless Hart (ISO/IEC62591-1), ISA100.11a (ISO/IEC 62734), a constrained application protocol (CoAP), a message queuing telemetry transport (MQTT), a wireless broadband (WIBro), Wimax, 3G, a high speed downlink packet access (HSDPA), 4G, 5G, 6G, etc. According to some embodiments of the present disclosure, the communication network 450 may be an Internet network or a mobile communication network. In addition, the communication network 450 may include any wireless or wired communication that is well known or will be developed in the future.

FIG. 2 is a block diagram for illustrating a device for detecting crises according to an embodiment of the present disclosure.

Referring to FIGS. 1 and 2, a device for detecting crises 100 may include a communication unit 10, an input unit 30, a control unit 50, an output unit 70, and a storage unit 90.

The communication unit 10 may communicate with the document providing device 200 and the user terminal 300. The communication unit 10 may transmit, to the document providing device 200, a message to request literature related to crisis indices for each industry and domestic/foreign crisis detection and literature on the momentum theory that reflects the trend of crisis indices and the crisis index up-side risk that reflects volatility, and may receive the requested literature from the document providing device 200. The communication unit 10 may transmit information on crises for each industry to the user terminal 300.

The input unit 30 may receive literature related to crisis indices for each industry and domestic/foreign crisis detection from a user. In addition, the input unit 30 may receive literature on the momentum theory that reflects the trend of crisis indices and the crisis index up-side risk that reflects volatility. Here, commands for controlling the process of predicting crises for each industry may also be input by the user.

The control unit 50 may generally control the crisis detection device 100. The control unit 50 may redefine crises and crisis detection for each industry. In other words, the control unit 50 may redefine crisis and crisis detection by distinguishing between the concepts of industrial decline and crisis in order to clarify the significance of developing a crisis detection model. The control unit 50 may analyze domestic/foreign related literature to design a crisis detection model with high prediction accuracy. In addition, the control unit 50 may analyze the momentum theory that reflects the trend of the past crisis indices and the crisis index up-side risk that reflects volatility. The control unit 50 may use the analysis results to calculate a crisis detection model that reflects the slope of the trend of the past crisis indices of the momentum theory and a crisis detection model that reflects the volatility of the crisis index of the crisis index up-side risk. The control unit 50 may adjust the proportions of the two crisis detection models to create one crisis detection model. Here, the crisis detection model may be a model that reflects both of the trend and the volatility to be applied when predicting the future crisis index. The control unit 50 may predict crises for each industry based on the crisis detection model that has been created.

The output unit 70 may output documents obtained by the communication unit 10 or the input unit 30. The output unit 70 may output the process of detecting crises for each industry based on the redefined meanings of crisis and crisis detection. Here, the output unit 70 may output the detected crises in the form of a graph in which they change according to time series.

The storage unit 90 may store a program or algorithm for driving the crisis detection device 100. The storage unit 90 may store documents obtained by the communication unit 10 or the input unit 30. The storage unit 90 may store information generated in the process of detecting crises for each industry based on the redefined meanings of crisis and crisis detection. The storage unit 90 may include at least one of the following storage media: flash memory type, hard disk type, multimedia card micro type, card type memory (e.g., a SD or XD memory, etc.), a random-access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

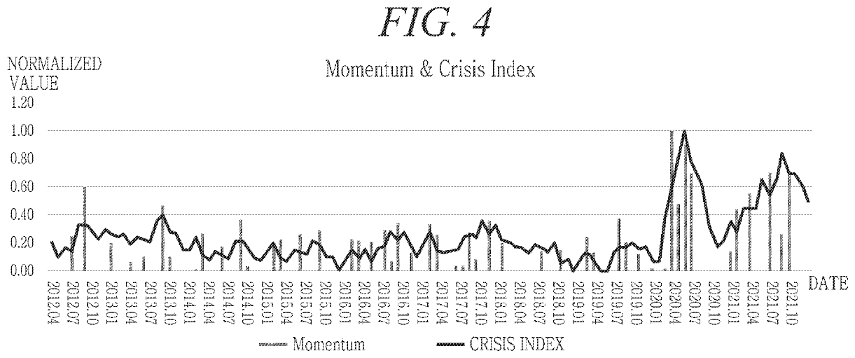

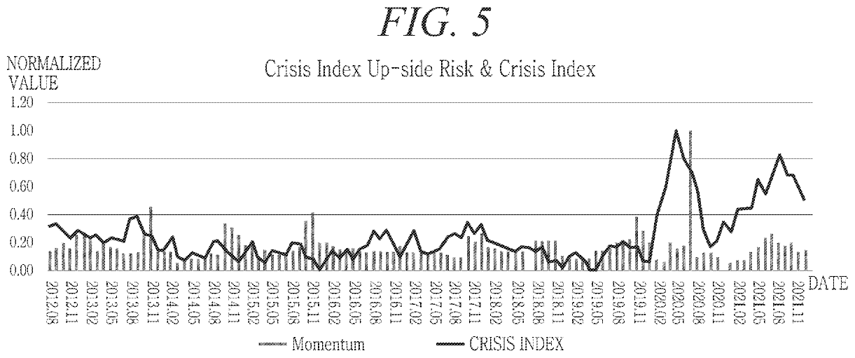

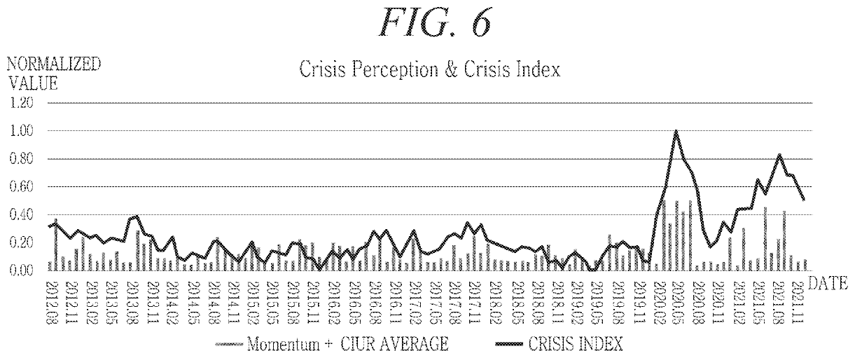

FIG. 3 is a block diagram for illustrating the control unit according to an embodiment of the present disclosure, FIG. 4 is a diagram for comparing the momentum and the crisis index of the automobile and trailer manufacturing industry according to an embodiment of the present disclosure, FIG. 5 is a diagram for comparing the crisis index up-side risk and the crisis index of the automobile and trailer manufacturing industry according to an embodiment of the present disclosure, and FIG. 6 is a diagram for comparing the crisis detection model and the crisis index of the automobile and trailer manufacturing industry according to an embodiment of the present disclosure.

Referring to FIGS. 2 to 6, the control unit 50 may include a definition setting unit 51, a document analysis unit 53, a model creation unit 55, and a crisis prediction unit 57.

The definition setting unit 51 may redefine meanings related to crises and crisis detection for each industry. In general, a crisis defined in the dictionary means a dangerous juncture or period, and, academically, it means that external factors such as safety, boundaries, politics, society, and the environment suddenly pose a risk to individuals, companies, society, etc., causing instability thereof. However, according to the present disclosure, in order to clarify the meaning of crisis detection, the concepts of decline and crisis may be distinguished, and then the meaning of crisis may be redefined. In other words, the definition setting unit 51 may redefine crisis as a phenomenon in which a crisis index rises due to internal and external changes in each industry. In addition, the definition setting unit 51 may redefine crisis detection as a phenomenon in which a crisis index rapidly rises above a preset reference value. Here, the crisis index may be a figure calculated based on literature related to indices for at least one of each industry, the economy, and foreign and domestic variables, and a rise in the crisis index may be interpreted as a sign that a crisis is approaching in the industry.

The document analysis unit 53 may analyze literature related to crisis and crisis detection with the meanings redefined by the definition setting unit 51. The document analysis unit 53 may analyze literature related to at least one of the status of research on the development of crisis detection models at the national project level, the status of research on variables affecting crisis detection at the corporate level, the status of research on the development of crisis detection models at the corporate level, prior overseas research on crisis prediction models, the momentum theory, and the crisis index up-side risk. The status of research on the development of crisis detection models at the national project level may be an indicator of a crisis detection model studied by the country, and may include literature regarding a national warning system built to predict and manage market stability in various aspects by creating a comprehensive system for managing national crises, an early warning system built to be used in the social/economic field, including finance, foreign affairs, oil, real estate, raw materials, labor, etc., and the like.

The status of research on variables affecting crisis detection at the corporate level may be an indicator of variables that affect crisis detection by companies, and may include literature regarding indicators of risk judgment in a consolidated financial reporting environment, insolvency rates for each industry predicted based on financial and non-financial factors, bankruptcy prediction models for externally audited companies based on financial ratios, economic fluctuations, etc.

The status of research on the development of crisis detection models at the corporate level may be an indicator of crisis detection models studied by companies, and may include literature regarding models for calculating early warning indices, signaling approaches to financial crises, indicators of management crises in public institutions, prior research on corporate-level crisis prediction models, etc.

Overseas prior research on crisis prediction models may be an indicator of crisis prediction models developed or being studied overseas, and may include literature regarding signal approach models, the global economic situation and the domestic demand status, research reflecting environment, social, and governance (ESG) factors, etc.

The momentum theory is a theory for predicting the future based on momentum, an indicator for measuring how much the upward or downward trend of a crisis index will accelerate. The momentum theory may be used to predict in which direction a crisis will progress based on changes in past crisis indices. For example, in physics, momentum refers to the momentum or the acceleration of a moving object, the momentum in the stock market refers to an indicator for measuring how much the upward or downward trend in stock prices will accelerate, and the momentum in finance refers to an indicator for measuring how much the upward or downward trend in a company's performance will accelerate. In other words, according to momentum theory, when a crisis index continues to rise while the slope of momentum slows, it can be predicted that there is a high possibility that the crisis index will decrease in the future. Likewise, when a crisis index continues to fall while the slope of momentum slows, it can be predicted that there is a high possibility that the crisis index will rise.

The crisis index up-side risk is a redesign of the model derived from the concept of earning down-side risk (EDR). In other words, the earning down-side risk focuses on the lower-than-expected volatility of profits based on the assumption that profits are asymmetrically distributed and the risk to profits is mainly downward, but the crisis index up-side risk focuses on the pattern of a crisis index moving upward.

The model creation unit 55 may create a crisis detection model based on the momentum theory reflecting the trend of crisis indices and the crisis index up-side risk reflecting volatility, considering the results of the analysis by the document analysis unit 53.

The model creation unit 55 may calculate a normalized momentum value with a probability of an increase in a crisis index based on the momentum theory. In detail, the model creation unit 55 may check the trend of the crisis index and measure changes in the trend line of the crisis index. Here, the model creation unit 55 may calculate the slope of the trend line at the time of observation and derive the value of the slope of the calculated trend line as the momentum value at the time of observation of the crisis index. Here, a large slope of the crisis detection trend line may mean that the crisis index can be predicted to rise, and a small slope may mean that the crisis index can be predicted to fall. Since the model creation unit 55 is used for crisis detection models, it may exclude momentum values with a negative slope value (crisis index falling) and use momentum values with an increasing slope of the trend line as a crisis detection value. The model creation unit 55 may normalize a momentum value to a value between 0 and 1.

The model creation unit 55 may use the crisis index up-side risk to calculate the value of the crisis index up-side risk focusing on the volatility of the past six periods. In detail, the model creation unit 55 may calculate the crisis index at a specific time point (t) by collecting information from the past time point (t−1) as shown in Equation 1.

$$Crisis {Index}_{t} = α + \sum Various {Variables}_{t - 1} + ϵ \qquad [ Equation 1 ]$$

The value of the unexpected crisis index in period t may be defined as a value that exceeds or falls below an expected value when the value of the crisis index calculated by inputting various indices in period t−1 is set to the expected level. (ϵ is the residual).

The model creation unit 55 may directly use how much the expected value of the crisis index deviates from that of the previous year (the non-expected level: the difference value obtained when the crisis index rises or falls compared to the past index). The model creation unit 55 may calculate the value of the crisis index up-side risk by calculating the ratio of values above the expected level (ϵ>0) and below the expected level (ϵ<=0), based on residuals, which are values outside the calculated expected level. Here, the model creation unit 55 may calculate the value of the crisis index up-side risk as shown in Equation 2.

$${CIUR}_{i} = LN [ \frac{1 + {[ ( \frac{1}{N} ) \sum {( \hat{ϵ} \times I {\hat{ϵ}}_{> 0} )}^{2} ]}^{1 / 2}}{1 + {[ ( \frac{1}{N} ) \sum {( \hat{ϵ} \times I {\hat{ϵ}}_{\leq 0} )}^{2} ]}^{1 / 2}} ] \qquad [ Equation 2 ]$$

I\hat{ϵ}≤0 denotes a dummy variable with a value of 1 when ϵ has a positive value and 0 otherwise, I\hat{ϵ}≤0 denotes a dummy variable with a value of 1 when \hat{ϵ} has a negative or 0 value and 0 otherwise, and N denotes the number of residuals. The value of the crisis index up-side risk (CIUR) may be in the range of 0 to 1, which can be interpreted as an expected value of a crisis index exceeding an expected level.

Here, the model creation unit 55 may focus on the volatility in the past six periods using six non-expected values, since the crisis index has not decreased or increased continuously (that is, continuously for half a year) during the six periods.

Meanwhile, as shown in FIGS. 5 and 6, the momentum theory and the crisis index up-side risk may provide a means of predicting the future based on past information, but may have limitations in that they do not reflect current and future information. Therefore, the model creation unit 55 may create a crisis detection model based on all of the trend of a crisis index, momentum, and volatility to improve the accuracy of predicting the future. That is, the model creation unit 55 may create a crisis detection model based on the normalized momentum value and the value of the crisis index up-side risk, which have been calculated. Here, the model creation unit 55 may generate a crisis detection model by averaging the normalized momentum value and the value of the crisis index up-side risk. As a result, unlike the crisis detection value based on either the momentum theory or the crisis index up-side risk, the model creation unit 55 may be capable of improving the accuracy of prediction of the rise in crisis while showing a somewhat stable trend (FIG. 6).

The crisis prediction unit 57 may predict crises for each industry based on a crisis detection model generated by the model creation unit 55. The crisis prediction unit 57 may apply the past crisis index to the crisis detection model to predict crises in the period after period t, period t+1, and period t+2. Here, the crisis prediction unit 57 may predict the future by analyzing the causal relationship between the crisis index and the crisis detection model. Desirably, the crisis prediction unit 57 may use the crisis detection model to analyze the background of the time point when the trend of the past crisis index changed suddenly and further use the results of the analysis to predict crisis. For example, the crisis prediction unit 57 may analyze the phenomenon where the crisis index has risen sharply in all industries since the second quarter of 2020 due to the outbreak of the coronavirus in the fourth quarter of 2019, and then predict that the crisis index is likely to rise for industries that are shrinking further due to the coronavirus pandemic.

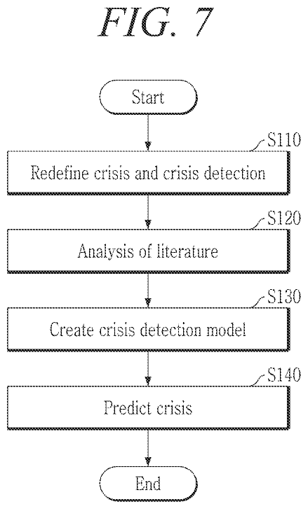

FIG. 7 is a flowchart for illustrating a method of detecting a crisis according to an embodiment of the present disclosure.

Referring to FIGS. 1 and 7, by the method of detecting a crisis, crises for each industry may be predicted based on the momentum theory, which reflects the trend of the past crisis indices, and the crisis index up-side risk, which reflects volatility, thereby improving the accuracy of prediction of the crises. Through the method of detecting a crisis, it may be possible to quickly respond to crisis in each industry in a specific and detailed manner based on the prediction of the crises. Consequently, it may be possible to build systems for predicting crises for each industry based on the method of detecting a crisis.

At S110, the crisis detection device 100 may redefine the meanings of crisis and crisis detection. The crisis detection device 100 may redefine a crisis as a phenomenon in which a crisis index increases due to internal and external changes in an industry. The crisis detection device 100 may redefine crisis detection as a phenomenon in which a crisis index rapidly rises above a preset reference value. Here, the crisis index may be a figure calculated based on literature related to indices for at least one of each industry, the economy, and foreign and domestic variables, and a rise in the crisis index may be interpreted as a sign that a crisis is approaching in the industry.

At S120, the crisis detection device 100 may analyze literature on the crisis and the crisis detection that have been redefined. The crisis detection device 100 may analyze literature related to at least one of the status of research on the development of crisis detection models at the national project level, the status of research on variables affecting crisis detection at the corporate level, the status of research on the development of crisis detection models at the corporate level, prior overseas research on crisis prediction models, the momentum theory, and the crisis index up-side risk.

At S130, the crisis detection device 100 may create a crisis detection model based on the momentum theory reflecting the trend of crisis indices and the crisis index up-side risk reflecting volatility, considering the analysis results. The crisis detection device 100 may calculate a normalized momentum value with a probability of an increase in a crisis index based on the momentum theory. The crisis detection device 100 may use the crisis index up-side risk to calculate the value of the crisis index up-side risk focusing on the volatility of the past six periods. The crisis detection device 100 may create a crisis detection model based on the normalized momentum value and the value of the crisis index up-side risk, which have been calculated. Here, the crisis detection device 100 may generate a crisis detection model by averaging the normalized momentum value and the value of the crisis index up-side risk.

At S140, the crisis detection device 100 may predict crises for each industry based on a crisis detection model that has been generated. The crisis detection device 100 may apply the past crisis index to the crisis detection model to predict crises in the period after period t, period t+1, and period t+2. Here, the crisis detection device 100 may predict the future by analyzing the causal relationship between the crisis index and the crisis detection model. Desirably, the crisis detection device 100 may use the crisis detection model to analyze the background of the time point when the trend of the past crisis index changed suddenly and further use the results of the analysis to predict crisis.

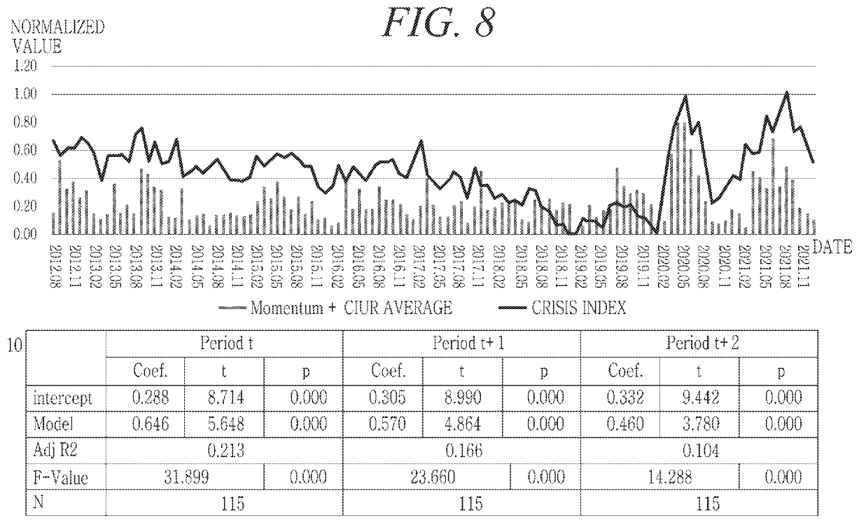

FIGS. 8 to 31 are views for illustrating the test of the results of predicting crises for each industry calculated by the device for detecting crises according to an embodiment of the present disclosure.

FIGS. 8 to 32 show the results of a regression analysis of the impact of crisis detection on crisis indices for the industries listed in Table 1 through the crisis detection device 100 according to the present disclosure.

TABLE 1

| | Industry | t | t + 1 | t + 2 |
|---|---|---|---|---|
| 10 | Food manufacturing | *** | *** | *** |
| 11 | Beverage manufacturing | *** | *** | *** |
| 12 | Tobacco manufacturing | — | — | — |
| 13 | Textile product manufacturing | *** | *** | *** |
| | (excluding clothing) | | | |
| 14 | Manufacturing of clothing, clothing accessories, | *** | *** | *** |
| | and fur products | | | |
| 15 | Leather, bag, and shoe manufacturing | *** | *** | *** |
| 16 | Manufacturing of wood and wood products | *** | *** | ** |
| | (excluding furniture) | | | |
| 17 | Pulp paper and paper products manufacturing | *** | *** | *** |
| 18 | Printing and recording media | *** | *** | *** |
| | reproduction business | | | |
| 19 | Manufacturing of coke briquette and refined | *** | *** | *** |
| | petroleum product | | | |
| 20 | Chemicals and chemical products manufacturing | *** | *** | *** |
| | (excluding pharmaceuticals) | | | |
| 21 | Manufacturing of medical substances | * | — | — |
| | and pharmaceuticals | | | |
| 22 | Rubber and plastic product manufacturing | *** | *** | *** |
| 23 | Non-metallic mineral products manufacturing | *** | *** | *** |
| 24 | Primary metal manufacturing | *** | *** | *** |
| 25 | Metal processing manufacturing | *** | *** | *** |
| 26 | Manufacturing of electronic components, | *** | *** | *** |
| | computers, and video, audio, and | | | |
| | communication equipment | | | |
| 27 | Manufacturing of medical, precision, and | *** | *** | *** |
| | optical equipment and watches | | | |
| 28 | Electrical equipment manufacturing | *** | *** | *** |
| 29 | Other machinery and equipment manufacturing | *** | *** | *** |
| 30 | Automobile and trailer manufacturing | *** | *** | *** |
| 31 | Other transportation equipment manufacturing | *** | *** | *** |
| 32 | Furniture manufacturing | *** | *** | *** |
| 33 | Other product manufacturing | *** | *** | *** |

Here, ***, **, and * mean that there is statistical significance of 1%, 5%, and 10%, respectively.

FIG. 8 relates to the prediction of the crisis in the food manufacturing industry (#10). It was confirmed that the impact of the crisis index values estimated based on the momentum and the crisis index up-side risk on the future crisis indices had a positive (+) value in all of period t, period t+1, and period t+2 in the food manufacturing industry. Here, it was confirmed that the time point when the crisis index of the food manufacturing industry rose sharply fell within the period when the coronavirus was prevalent. In detail, it was assumed that the sharp rise in the crisis index had been caused by the decline in prices of agricultural products due to the weakening prices in the raw materials market and the harvest in the Northern Hemisphere in the second quarter of 2020 and the export competition of wheat supply countries that was intensified in the fourth quarter of 2021 as they reached harvest time.

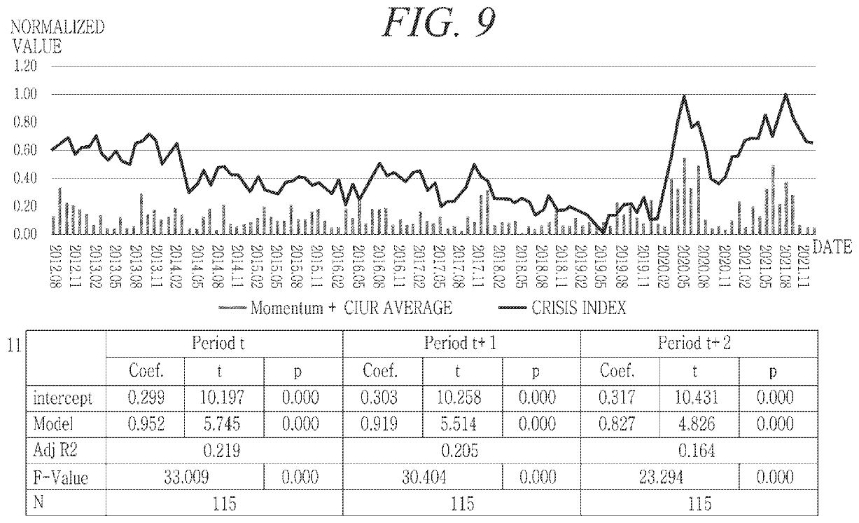

FIG. 9 relates to the prediction of the crisis in the beverage manufacturing industry (#11). It was confirmed that the impact of the crisis index values estimated based on the momentum and the crisis index up-side risk on the future crisis indices had a positive (+) value in all of period t, period t+1, and period t+2 in the beverage manufacturing industry. Here, it was confirmed that the time point when the crisis index of the beverage manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

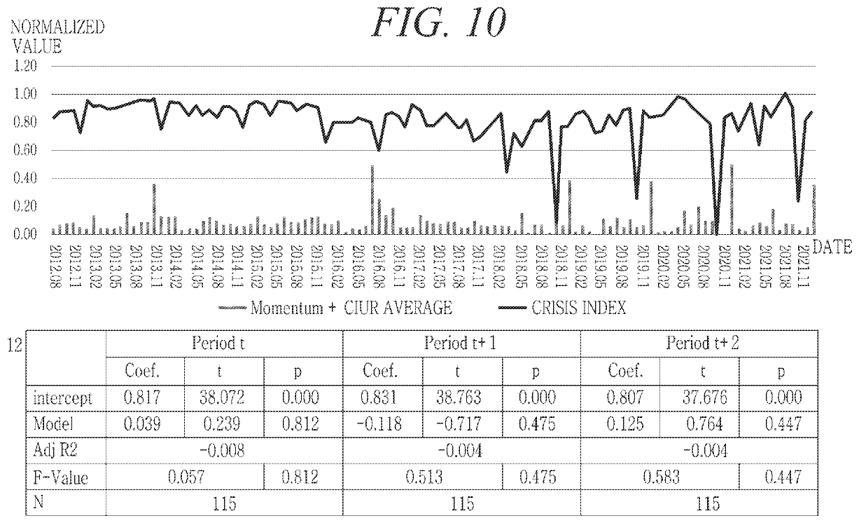

FIG. 10 relates to the prediction of the crisis in the tobacco manufacturing industry (#12). In the tobacco manufacturing industry, the impact of the crisis index values estimated based on the momentum and the crisis index up-side risk on the future crisis indices did not have a statistically significant resulting value for all the periods. It was assumed that it was because the crisis index values were consistently high.

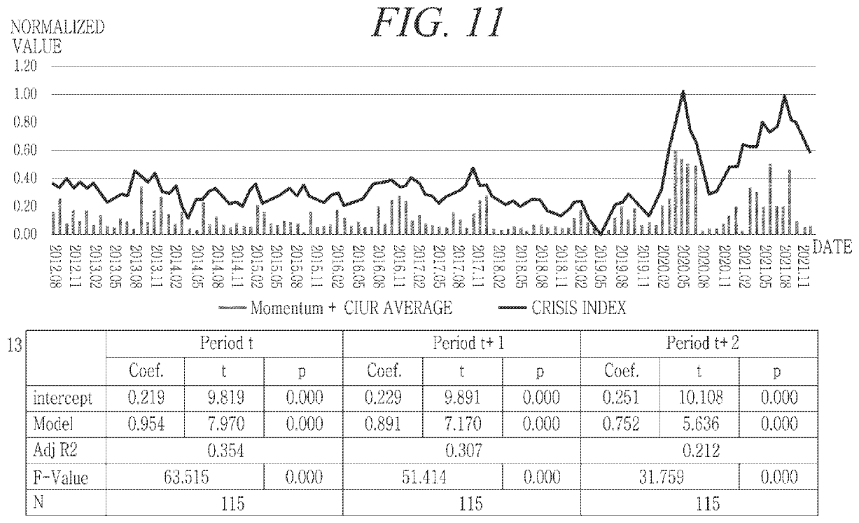

FIG. 11 relates to the prediction of the crisis in the textile product manufacturing industry (excluding clothing) (#13). It was confirmed that the impact of the crisis index values estimated based on the momentum and the crisis index up-side risk on the future crisis indices had a positive (+) value in all of period t, period t+1, and period t+2 in the textile product manufacturing industry. Here, it was confirmed that the time point when the crisis index of the textile product manufacturing industry (excluding clothing) rose sharply fell within the period when the coronavirus was prevalent. Specifically, it was assumed that, as the coronavirus pandemic worsened and social distancing became more common in the second quarter of 2020, the industry had suffered a serious crisis.

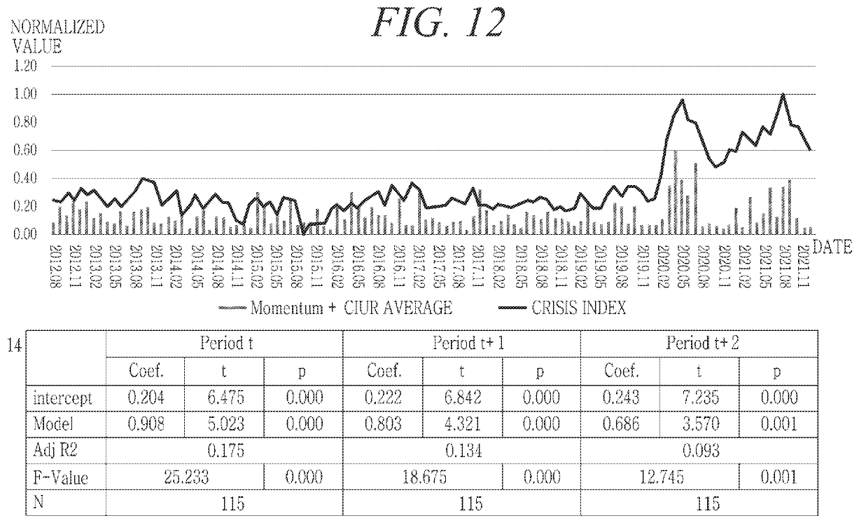

FIG. 12 relates to the prediction of the crisis in the manufacturing of clothing, clothing accessories, and fur products (#14). It was confirmed that the impact of the crisis index values estimated based on the momentum and the crisis index up-side risk on the future crisis indices had a positive (+) value in all of period t, period t+1, and period t+2 in the manufacturing of clothing, clothing accessories, and fur products. Here, it was confirmed that the time point when the crisis index of the manufacturing of clothing, clothing accessories, and fur products rose sharply fell within the period when the coronavirus was prevalent. Specifically, it was assumed that, as the coronavirus pandemic worsened and social distancing became more common in the second quarter of 2020, the industry had suffered a serious crisis.

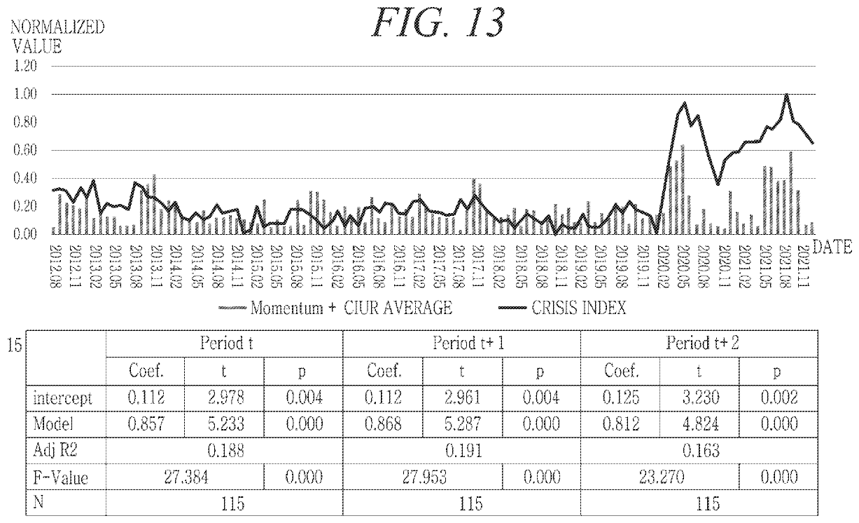

FIG. 13 relates to the prediction of the crisis in the leather, bag, and shoe manufacturing industry (#15). It was confirmed that the impact of the crisis index values estimated based on the momentum and the crisis index up-side risk on the future crisis indices had a positive (+) value in all of period t, period t+1, and period t+2 in the leather, bag, and shoe manufacturing industry. Here, it was confirmed that the time point when the crisis index of the leather, bag, and shoe manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

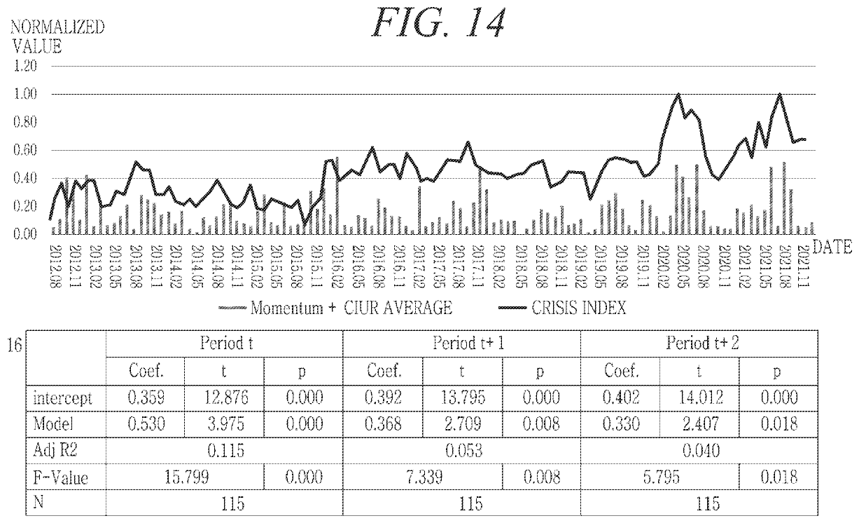

FIG. 14 relates to the prediction of the crisis in the manufacturing of wood and wood products (excluding furniture) (#16). It was confirmed that the impact of the crisis index values estimated based on the momentum and the crisis index up-side risk on the future crisis indices had a positive (+) value in all of period t, period t+1, and period t+2 in the manufacturing of wood and wood products (excluding furniture). Here, it was confirmed that the time point when the crisis index of the manufacturing of wood and wood products (excluding furniture) rose sharply fell within the period when the coronavirus was prevalent. Specifically, it was assumed that, as the coronavirus pandemic worsened and social distancing became more common in the second quarter of 2020, the industry had suffered a serious crisis.

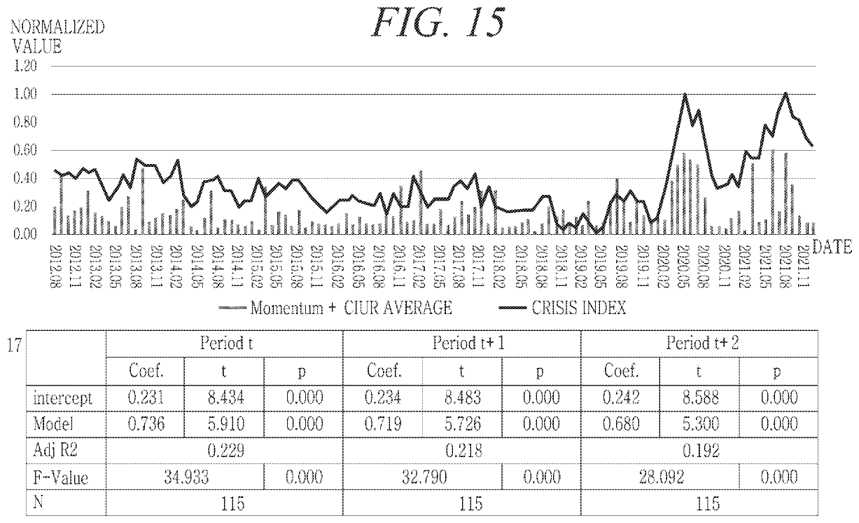

FIG. 15 relates to the prediction of the crisis in the pulp paper and paper products manufacturing industry (#17). It was confirmed that the impact of the crisis index values estimated based on the momentum and the crisis index up-side risk on the future crisis indices had a positive (+) value in all of period t, period t+1, and period t+2 in the pulp paper and paper products manufacturing industry. Here, it was confirmed that the time point when the crisis index of the pulp paper and paper products manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

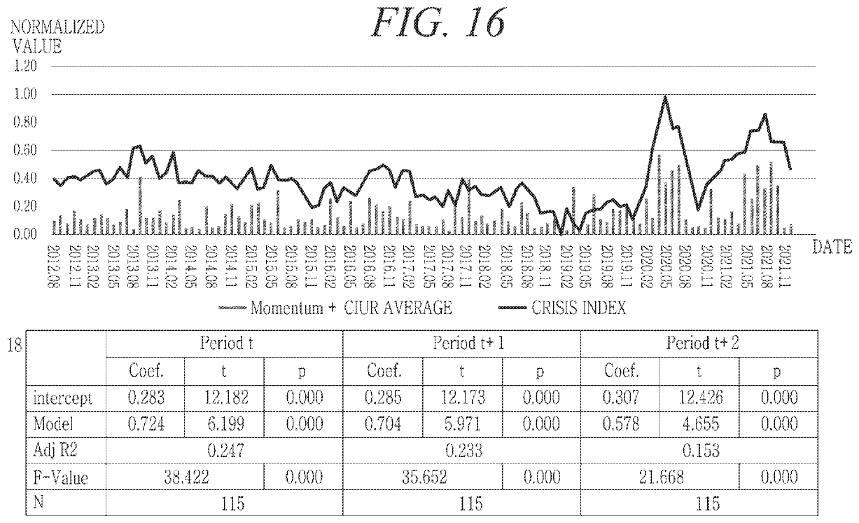

FIG. 16 relates to the prediction of the crisis in the printing and recording media reproduction business (#18). It was confirmed that the impact of the crisis index values estimated based on the momentum and the crisis index up-side risk on the future crisis indices had a positive (+) value in all of period t, period t+1, and period t+2 in the printing and recording media reproduction business. Here, it was confirmed that the time point when the crisis index of the printing and recording media reproduction business rose sharply fell within the period when the coronavirus was prevalent. Specifically, it was assumed that, as the coronavirus pandemic worsened and social distancing became more common in the second quarter of 2020, the industry had suffered a serious crisis.

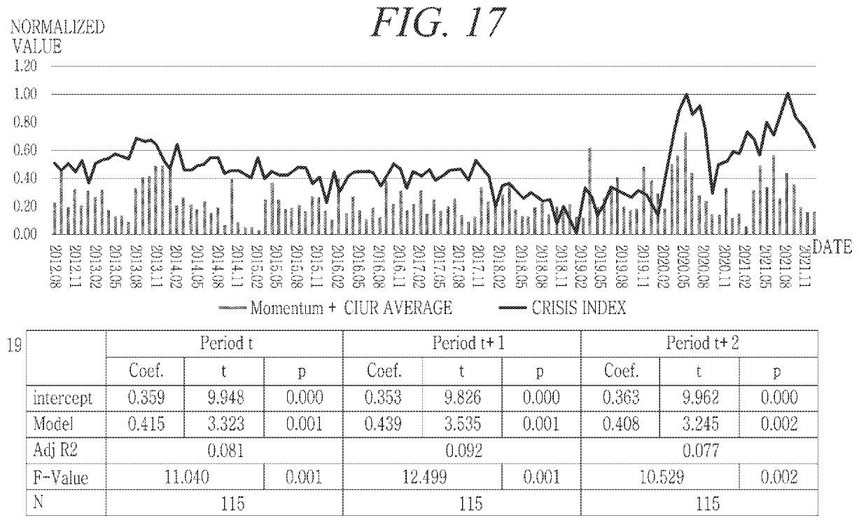

FIG. 17 relates to the prediction of the crisis in the manufacturing of coke briquette and refined petroleum product (#19). It was confirmed that the impact of the crisis index values estimated based on the momentum and the crisis index up-side risk on the future crisis indices had a positive (+) value in all of period t, period t+1, and period t+2 in the manufacturing of coke briquette and refined petroleum product. Here, it was confirmed that the time point when the crisis index of the manufacturing of coke briquette and refined petroleum product rose sharply fell within the period when the coronavirus was prevalent. Specifically, it was assumed that, as the coronavirus pandemic worsened and social distancing became more common in the second quarter of 2020, the industry had suffered a serious crisis.

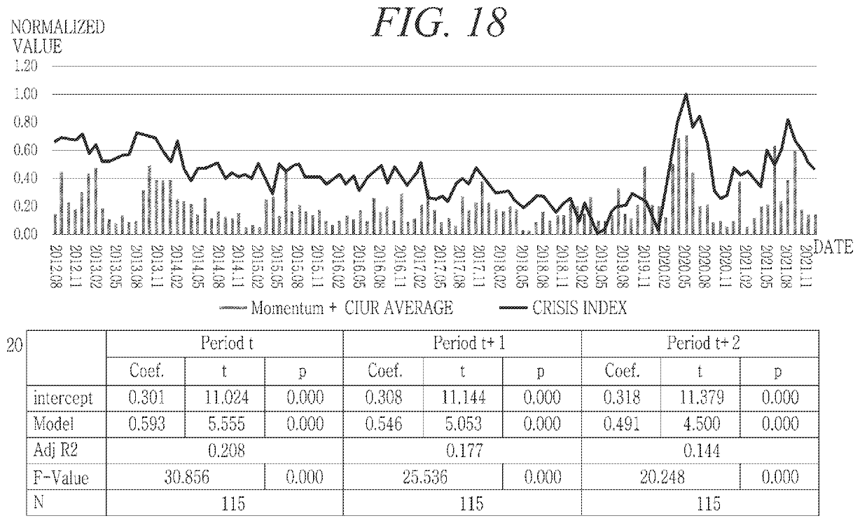

FIG. 18 relates to the prediction of the crisis in the chemicals and chemical products manufacturing industry (excluding pharmaceuticals) (#20). It was confirmed that the impact of the crisis index values estimated based on the momentum and the crisis index up-side risk on the future crisis indices had a positive (+) value in all of period t, period t+1, and period t+2 in the chemicals and chemical products manufacturing industry. Here, it was confirmed that the time point when the crisis index of the chemicals and chemical products manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

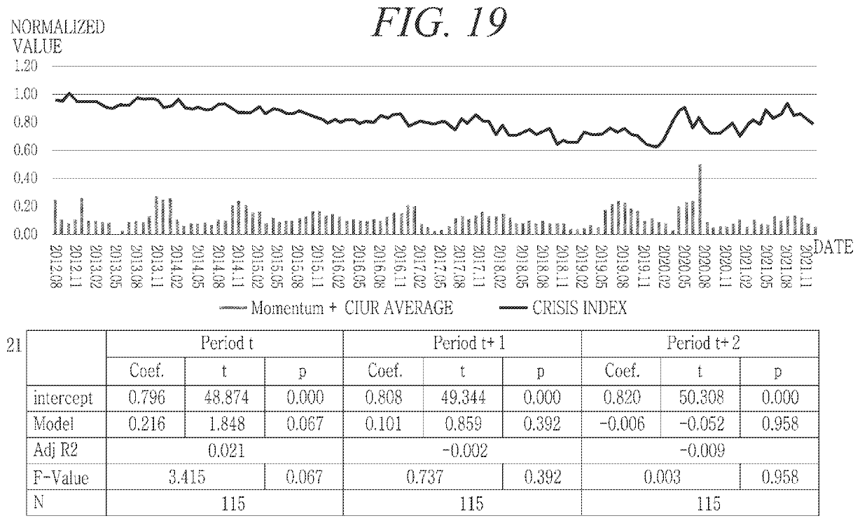

FIG. 19 relates to the prediction of the crisis in the manufacturing of medical substances and pharmaceuticals (#21). In the manufacturing of medical substances and pharmaceuticals, the impact of the crisis index values estimated based on the momentum and the crisis index up-side risk on the future crisis indices did not have a statistically significant resulting value for all the periods after period t. It was assumed that it was because the crisis index values were consistently high.

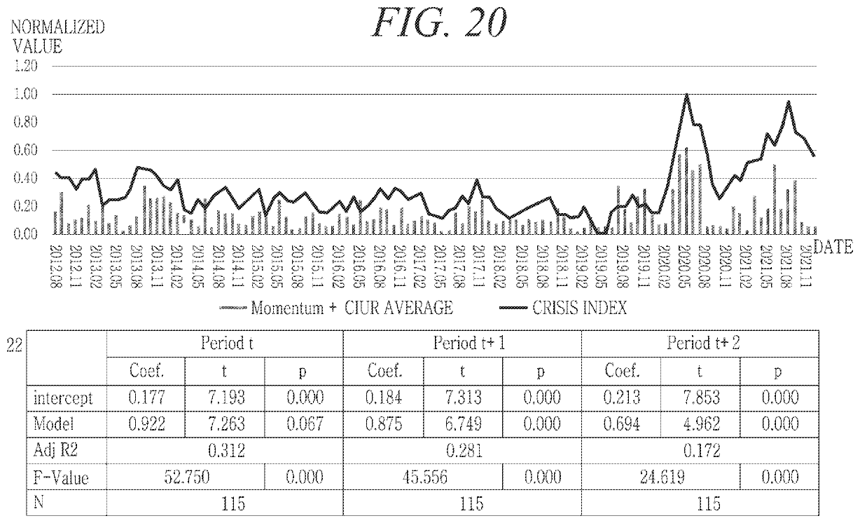

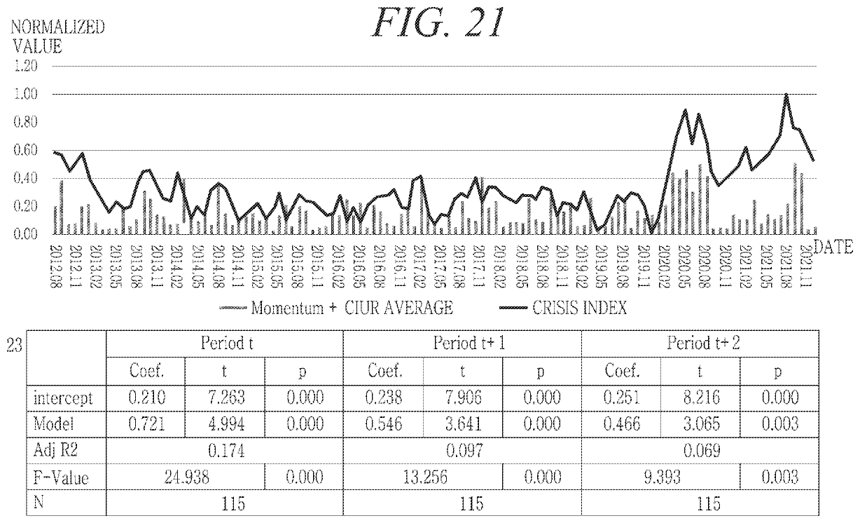

FIG. 20 relates to the prediction of the crisis in the rubber and plastic product manufacturing industry (#22). It was confirmed that the impact of the crisis index values estimated based on the momentum and the crisis index up-side risk on the future crisis indices had a positive (+) value in all of period t, period t+1, and period t+2 in the rubber and plastic product manufacturing industry. Here, it was confirmed that the time point when the crisis index of the rubber and plastic product manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

FIG. 21 relates to the prediction of the crisis in the non-metallic mineral products manufacturing industry (#23). It was confirmed that the impact of the crisis index values estimated based on the momentum and the crisis index up-side risk on the future crisis indices had a positive (+) value in all of period t, period t+1, and period t+2 in the non-metallic mineral products manufacturing industry. Here, it was confirmed that the time point when the crisis index of the non-metallic mineral products manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

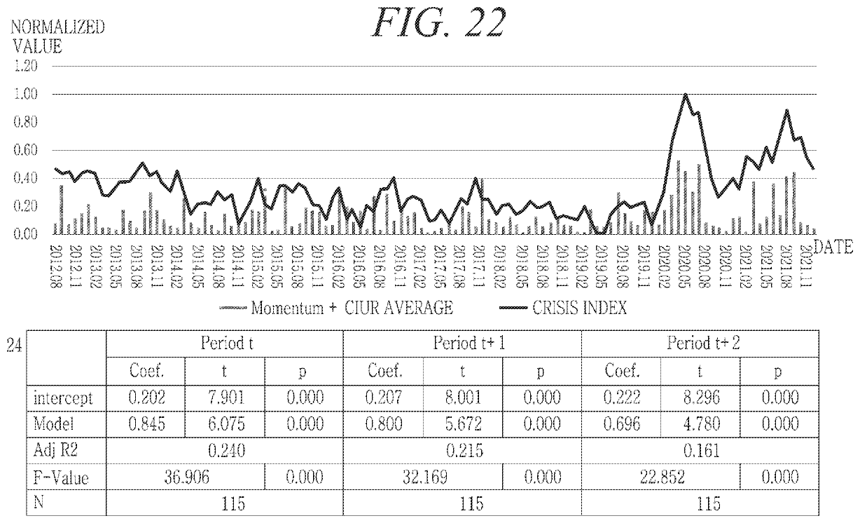

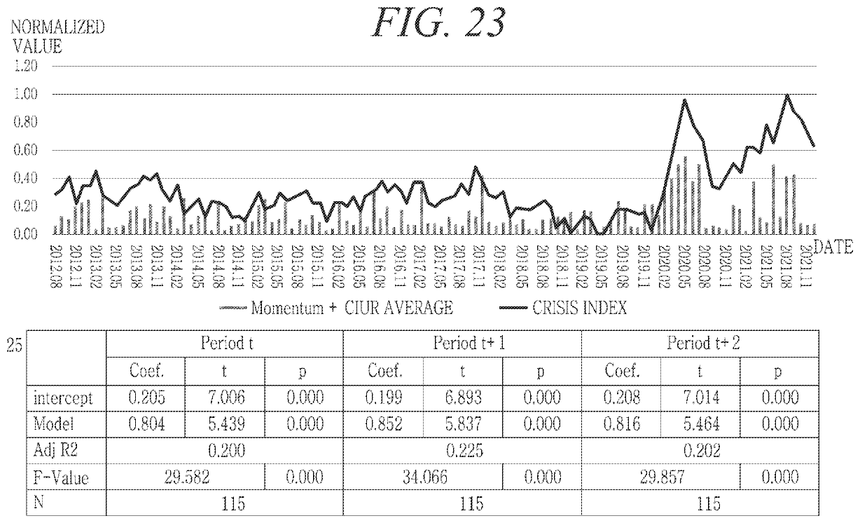

FIG. 22 relates to the prediction of the crisis in the primary metal manufacturing industry (#24). It was confirmed that the impact of the crisis index values estimated based on the momentum and the crisis index up-side risk on the future crisis indices had a positive (+) value in all of period t, period t+1, and period t+2 in the primary metal manufacturing industry. Here, it was confirmed that the time point when the crisis index of the primary metal manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

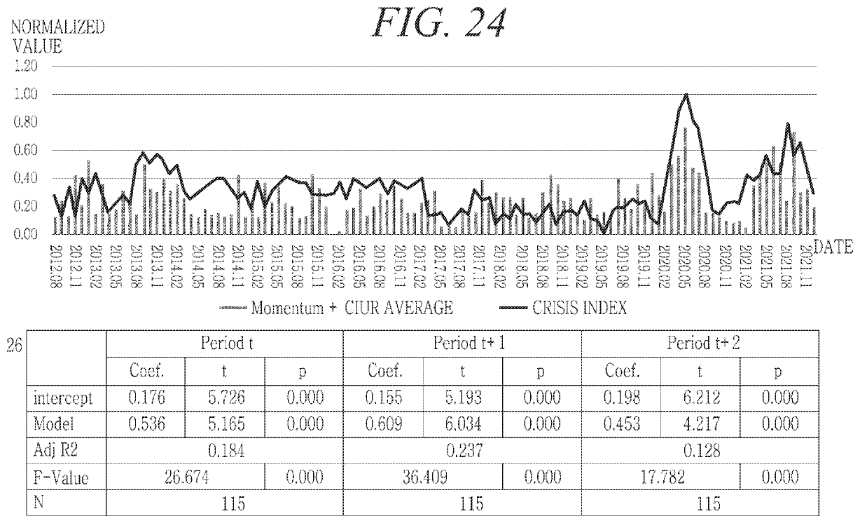

FIG. 23 relates to the prediction of the crisis in the metal processing manufacturing industry (#25). It was confirmed that the impact of the crisis index values estimated based on the momentum and the crisis index up-side risk on the future crisis indices had a positive (+) value in all of period t, period t+1, and period t+2 in the metal processing manufacturing industry. Here, it was confirmed that the time point when the crisis index of the metal processing manufacturing industry rose sharply fell within the period when the coronavirus was prevalent. Specifically, it was assumed that, as the coronavirus pandemic worsened and social distancing became more common in the second quarter of 2020, the industry had suffered a serious crisis.

FIG. 24 relates to the prediction of the crisis in the manufacturing of electronic components, computers, and video, audio, and communication equipment (#26). It was confirmed that the impact of the crisis index values estimated based on the momentum and the crisis index up-side risk on the future crisis indices had a positive (+) value in all of period t, period t+1, and period t+2 in the manufacturing of electronic components, computers, and video, audio, and communication equipment. Here, it was confirmed that the time point when the crisis index of the metal processing manufacturing industry rose sharply fell within the period when the coronavirus was prevalent. Specifically, it was assumed that, as the coronavirus pandemic worsened and social distancing became more common in the second quarter of 2020, the industry had suffered a serious crisis. In addition, it was found that a slight increase in the crisis index in 2013 had been caused by a decrease in demand for semiconductors and a fire that occurred at the company with a name starting with H.

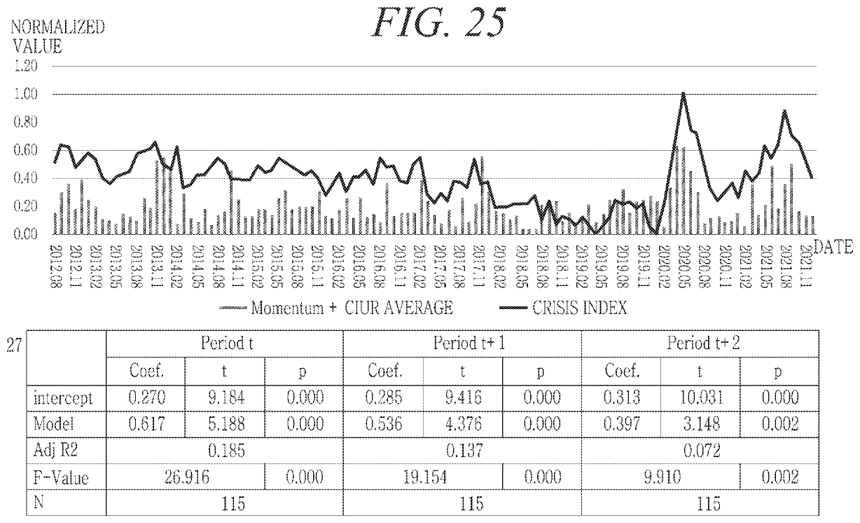

FIG. 25 relates to the prediction of the crisis in the manufacturing of medical, precision, and optical equipment and watches (#27). It was confirmed that the impact of the crisis index values estimated based on the momentum and the crisis index up-side risk on the future crisis indices had a positive (+) value in all of period t, period t+1, and period t+2 in the manufacturing of medical, precision, and optical equipment and watches. Here, it was confirmed that the time point when the crisis index of the manufacturing of medical, precision, and optical equipment and watches rose sharply fell within the period when the coronavirus was prevalent. Specifically, it was assumed that, as the coronavirus pandemic worsened and social distancing became more common in the second quarter of 2020, the industry had suffered a serious crisis. In addition, the demand for medical services increased during the coronavirus pandemic, but it was found that the demand for related precision devices had been higher for imported products than for domestic products.

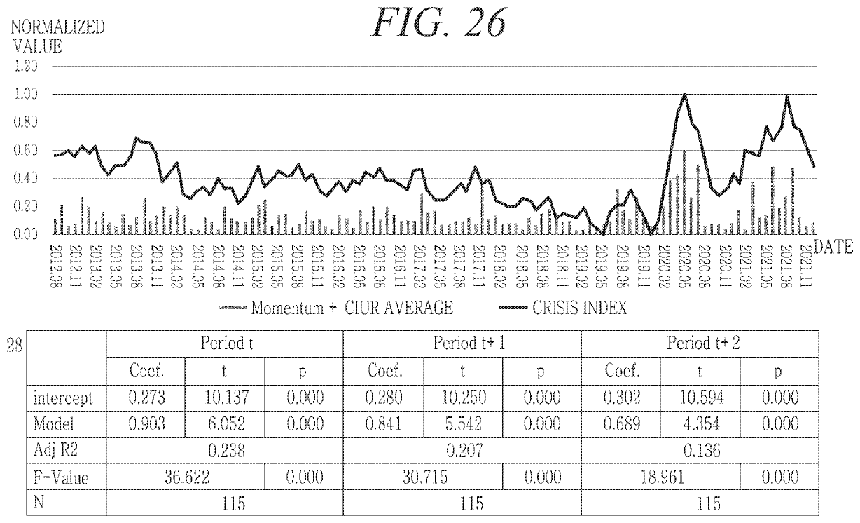

FIG. 26 relates to the prediction of the crisis in the electrical equipment manufacturing industry (#28). It was confirmed that the impact of the crisis index values estimated based on the momentum and the crisis index up-side risk on the future crisis indices had a positive (+) value in all of period t, period t+1, and period t+2 in the electrical equipment manufacturing industry. Here, it was confirmed that the time point when the crisis index of the electrical equipment manufacturing industry rose sharply fell within the period when the coronavirus was prevalent. Specifically, it was assumed that, as the coronavirus pandemic worsened and social distancing became more common in the second quarter of 2020, the industry had suffered a serious crisis. This is because the demand for electrical equipment decreased as the domestic economy was in recession due to the coronavirus pandemic. However, it was found that, as industries such as the electric vehicle industry developed, the crises in industries such as the primary batteries industry and the storage batteries industry had fallen.

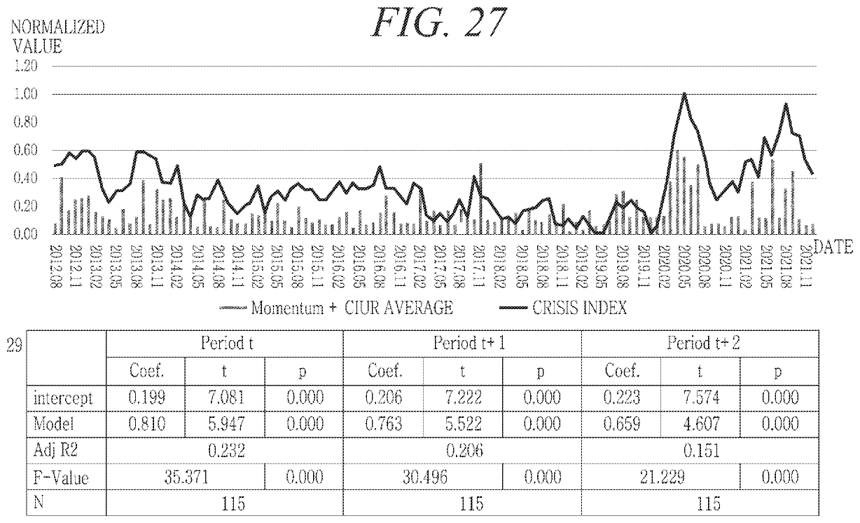

FIG. 27 relates to the prediction of the crisis in the other machinery and equipment manufacturing industry (#29). It was confirmed that the impact of the crisis index values estimated based on the momentum and the crisis index up-side risk on the future crisis indices had a positive (+) value in all of period t, period t+1, and period t+2 in the other machinery and equipment manufacturing industry. Here, it was confirmed that the time point when the crisis index of the other machinery and equipment manufacturing industry rose sharply fell within the period when the coronavirus was prevalent. Specifically, it was assumed that, as the coronavirus pandemic worsened and social distancing became more common in the second quarter of 2020, the industry had suffered a serious crisis. It was found that the demand for mechanical equipment had plummeted as the manufacturing industry contracted due to the economic downturn and the strict environmental regulations.

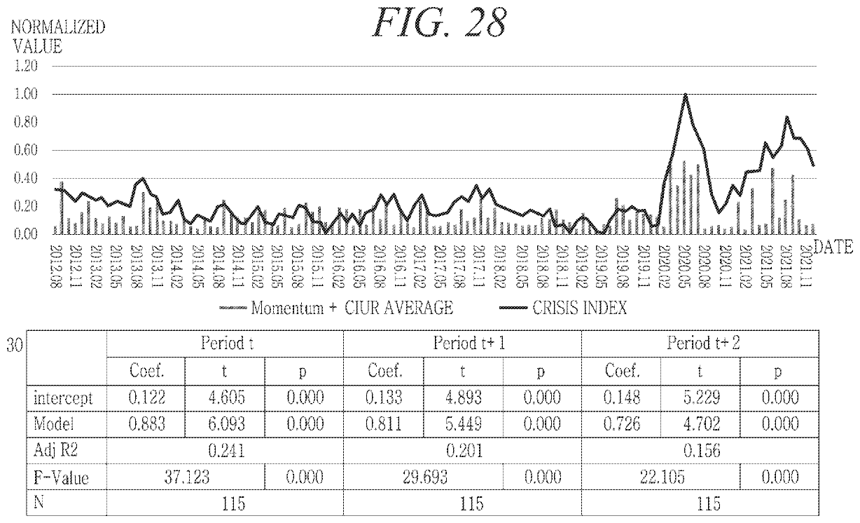

FIG. 28 relates to the prediction of the crisis in the automobile and trailer manufacturing industry (#30). It was confirmed that the impact of the crisis index values estimated based on the momentum and the crisis index up-side risk on the future crisis indices had a positive (+) value in all of period t, period t+1, and period t+2 in the automobile and trailer manufacturing industry. Here, it was confirmed that the time point when the crisis index of the automobile and trailer manufacturing industry rose sharply fell within the period when the coronavirus was prevalent. Specifically, it was assumed that, as the coronavirus pandemic worsened and social distancing became more common in the second quarter of 2020, the industry had suffered a serious crisis. In particular, it was found that the crisis index of the automobile-related industry has continuously risen as the production of automotive semiconductors has rapidly decreased worldwide, causing disruption in automobile production.

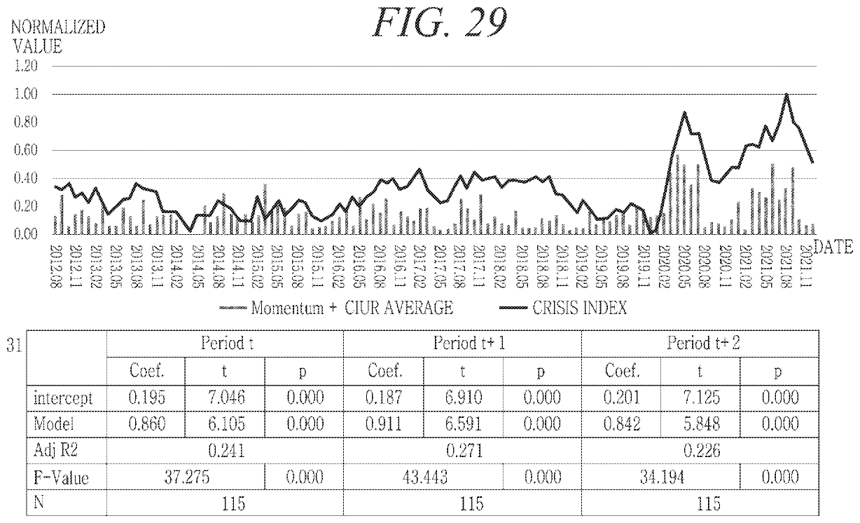

FIG. 29 relates to the prediction of the crisis in the other transportation equipment manufacturing industry (#31). It was confirmed that the impact of the crisis index values estimated based on the momentum and the crisis index up-side risk on the future crisis indices had a positive (+) value in all of period t, period t+1, and period t+2 in the other transportation equipment manufacturing industry. Here, it was confirmed that the time point when the crisis index of the other transportation equipment manufacturing industry rose sharply fell within the period when the coronavirus was prevalent. Specifically, it was assumed that, as the coronavirus pandemic worsened and social distancing became more common in the second quarter of 2020, the industry had suffered a serious crisis. In particular, it was found that the crisis index of the automobile-related industry has continuously risen as the production of automotive semiconductors has rapidly decreased worldwide, causing disruption in automobile production. Particularly, it was predicted that the demand for shipping and aviation services would decrease due to the lockdown policies implemented around the world during the coronavirus pandemic, resulting in a continuous increase in the crisis indices of the related industries.

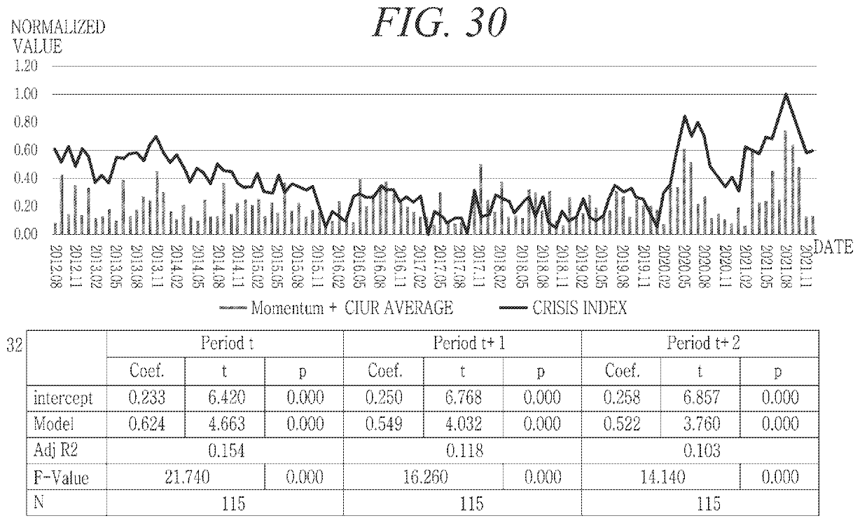

FIG. 30 relates to the prediction of the crisis in the furniture manufacturing industry (#32). It was confirmed that the impact of the crisis index values estimated based on the momentum and the crisis index up-side risk on the future crisis indices had a positive (+) value in all of period t, period t+1, and period t+2 in the furniture manufacturing industry. Here, it was confirmed that the time point when the crisis index of the furniture manufacturing industry rose sharply fell within the period when the coronavirus was prevalent. Specifically, it was assumed that, as the coronavirus pandemic worsened and social distancing became more common in the second quarter of 2020, the industry had suffered a serious crisis. In addition, since the furniture manufacturing industry is greatly affected by the economy, it was predicted that the demand for furniture would further decrease due to the economic downturn caused by the coronavirus pandemic.

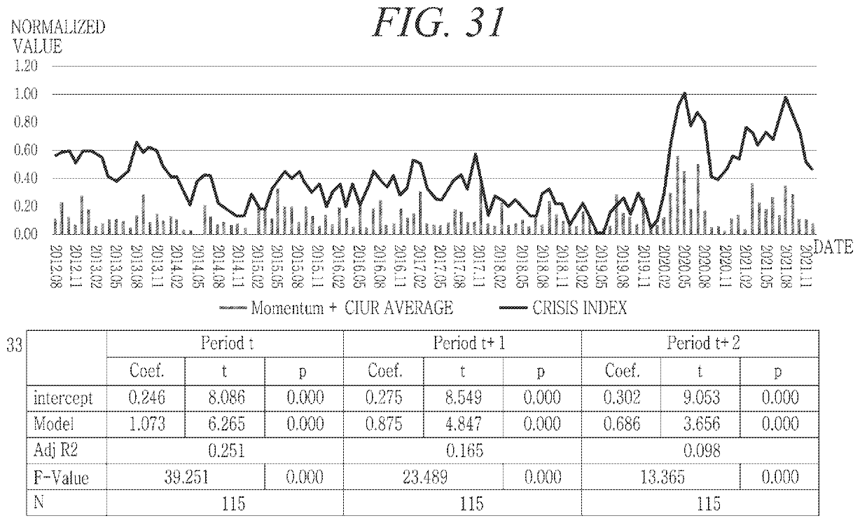

FIG. 31 relates to the prediction of the crisis in the other product manufacturing industry (#33). It was confirmed that the impact of the crisis index values estimated based on the momentum and the crisis index up-side risk on the future crisis indices had a positive (+) value in all of period t, period t+1, and period t+2 in the other product manufacturing industry. Here, it was confirmed that the time point when the crisis index of the other product manufacturing industry rose sharply fell within the period when the coronavirus was prevalent. Specifically, it was assumed that, as the coronavirus pandemic worsened and social distancing became more common in the second quarter of 2020, the industry had suffered a serious crisis. In particular, it was found that the jewelry manufacturing industry, sensitive to economic conditions, had been directly affected by the coronavirus pandemic while the demand for musical instruments, exercise equipment, etc. had recovered to some extent as the coronavirus pandemic was prolonged.

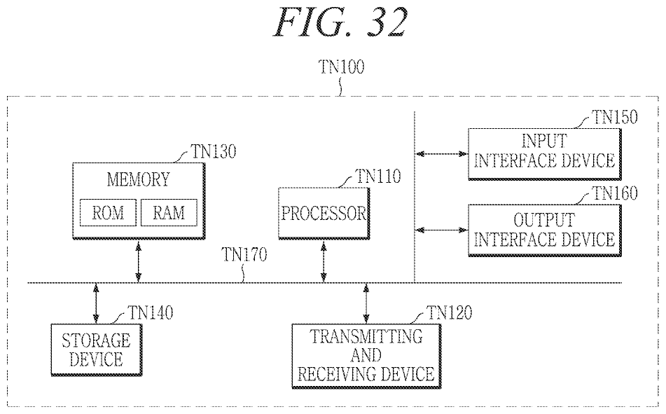

FIG. 32 is a block diagram for illustrating a computing device according to an embodiment of the present disclosure.

Referring to FIG. 32, a computing device TN100 may be a device described in the present disclosure (e.g., the crisis detection device, the document providing device, the user terminal, etc.).

The computing device TN100 may include at least one processor TN110, a transmitting and receiving device TN120, and a memory TN130. In addition, the computing device TN100 may further include a storage device TN140, an input interface device TN150, an output interface device TN160, etc. The components of the computing device TN100 may be connected by a bus TN170 and communicate with each other.

The processor TN110 may execute a program command stored in at least one of the memory TN130 and the storage device TN140. The processor TN110 may refer to a central processing unit (CPU), a graphics processing unit (GPU), or a dedicated processor for performing the methods according to the embodiments of the present disclosure. The processor TN110 may be designed to perform the procedures, the functions, the methods, etc. described in connection with the embodiments of the present disclosure. The processor TN110 may control each component of the computing device TN100.

The memory TN130 and the storage device TN140 may respectively store various information related to the operation of the processor TN110. Each of the memory TN130 and the storage device TN140 may include at least one of a volatile storage medium and a non-volatile storage medium. For example, the memory TN130 may include at least one of a read only memory (ROM) and a random-access memory (RAM).

The transmitting and receiving device TN120 may transmit or receive wired signals or wireless signals. The transmitting and receiving device TN120 may be connected to a network and perform communication.

Meanwhile, the embodiments of the present disclosure can also be carried out by devices and/or methods that have not been described herein and by programs for performing functions corresponding to their components or a recording medium on which the programs are recorded, and the description of the embodiments would enable a person having ordinary skill in the art to easily carry out the embodiments in such a manner.

Although the embodiments of the present disclosure have been described in detail above, the scope of the present disclosure is not limited thereto. Various modifications and improved forms that a person having ordinary skill in the art has made based on the basic concept of the present disclosure defined in the following claims also fall within the scope of the present disclosure.

What is claimed is:

1. A crisis detection device, comprising:
a definition setting unit that redefines the meanings of crisis and crisis detection for each industry;
a document analysis unit that analyzes literature on the crisis and the crisis detection that have been redefined;
a model creation unit that creates a crisis detection model based on the momentum theory reflecting the trend of a crisis index and the crisis index up-side risk (CIUR) reflecting volatility, considering the analysis results; and
a crisis prediction unit that predicts crises for each industry using the crisis detection model.

2. The crisis detection device of claim 1, wherein the definition setting unit redefines the crisis as a phenomenon in which a crisis index rises due to internal and external changes in each industry and the crisis detection as a phenomenon in which the crisis index rapidly rises above a preset reference value.

3. The crisis detection device of claim 1, wherein the document analysis unit analyzes literature related to at least one of the status of research on the development of crisis detection models at the national project level, the status of research on variables affecting crisis detection at the corporate level, the status of research on the development of crisis detection models at the corporate level, overseas prior research on crisis prediction models, the momentum theory, and the crisis index up-side risk.

4. The crisis detection device of claim 1, wherein the model creation unit calculates a normalized momentum value with a probability of an increase in a crisis index based on the momentum theory, uses the crisis index up-side risk to calculate the value of the crisis index up-side risk focusing on the volatility of the past six periods, and creates the crisis detection model based on the normalized momentum value and the value of the crisis index up-side risk.

5. The crisis detection device of claim 4, wherein the model creation unit generates the crisis detection model by averaging the normalized momentum value and the value of the crisis index up-side risk.

6. The crisis detection device of claim 1, wherein the crisis prediction unit applies the crisis index to the crisis detection model in order to predict crises in the period after period t, period t+1, and period t+2.

7. The crisis detection device of claim 1, wherein the crisis prediction unit uses the crisis detection model to analyze the background of the time point when the trend of the past crisis index changed suddenly and further uses the results of the analysis to predict the crisis.

8. A method of detecting crises performed by a crisis detection device that predicts a possible crisis for each industry, comprising:
redefining the meanings of crisis and crisis detection for each industry;
analyzing literature on the crisis and the crisis detection that have been redefined;
creating a crisis detection model based on the momentum theory reflecting the trend of a crisis index and the crisis index up-side risk reflecting volatility, considering the analysis results; and
predicting crises for each industry using the crisis detection model.

9. The method of detecting crises of claim 8, wherein the redefining of the meanings involves:
redefining the crisis as a phenomenon in which a crisis index rises due to internal and external changes in each industry; and
redefining the crisis detection as a phenomenon in which the crisis index rapidly rises above a preset reference value.

10. The method of detecting crises of claim 8, wherein the analyzing of the literature is for analyzing literature related to at least one of the status of research on the development of crisis detection models at the national project level, the status of research on variables affecting crisis detection at the corporate level, the status of research on the development of crisis detection models at the corporate level, prior overseas research on crisis prediction models, the momentum theory, and the crisis index up-side risk.

11. The method of detecting crises of claim 8, wherein the creating of a crisis detection model involves:
calculating a normalized momentum value with a probability of an increase in a crisis index based on the momentum theory;
using the crisis index up-side risk to calculate the value of the crisis index up-side risk focusing on the volatility of the past six periods; and
creating the crisis detection model based on the normalized momentum value and the value of the crisis index up-side risk.

12. The method of detecting crises of claim 8, wherein, in the predicting of crises for each industry, the crisis index is applied to the crisis detection model in order to predict crises in the period after period t, period t+1, and period t+2.

13. The method of detecting crises of claim 8, wherein, in the predicting of crises for each industry, the crisis detection model is used to analyze the background of the time point when the trend of the past crisis index changed suddenly, and the results of the analysis is further used to predict the crisis.

14. A system for detecting crises, comprising:
a document providing device that provides literature related to crisis indices for each industry and domestic/foreign crisis detection and literature related to the momentum theory that reflects the trend of crisis indices and the crisis index up-side risk that reflects volatility;
a crisis detection device that analyzes the provided literature, creates a crisis detection model based on the analysis results, and detects crises for each industry using the crisis detection model that has been created; and
a user terminal that receives information on the detected crises for each industry and outputs the received information in order to allow a user to prepare for the crises,
wherein the crisis detection device includes:
a definition setting unit that redefines the meanings of crisis and crisis detection for each industry;
a document analysis unit that analyzes literature on the crisis and the crisis detection that have been redefined;
a model creation unit that creates the crisis detection model based on the momentum theory and the crisis index up-side risk, considering the analysis results; and
a crisis prediction unit that predicts crises for each industry using the crisis detection model.
